(19) United States
(12) Patent Application Publication
(10) Pub. No.: US 2024/0231197 A9
(43) Pub. Date: Jul. 11, 2024

(54) SURVEILLANCE CAMERA MODULE WITH A ROTATION COUPLING STRUCTURE

(71) Applicant: TVKOREA INCORPORATED, Seongnam-si (KR)

(72) Inventor: Jae-Hoon LEE, Seoul (KR)

(21) Appl. No.: 18/273,271

(22) PCT Filed: Jun. 7, 2021
(86) PCT No.: PCT/KR2021/007086

§ 371 Date: Jul. 19, 2023

(30) Foreign Application Priority Data
Jan. 22, 2021 (KR) 10-2021-0009392

(51) Int. Cl. G03B 17/56; H04N 7/18; H04N 23/51; H04N 23/695

(52) U.S. Cl. CPC G03B 17/561; H04N 7/183; H04N 23/51; H04N 23/695

(57) ABSTRACT

Provided is a surveillance camera with a rotation coupling structure. A surveillance camera module with a rotation coupling structure includes a camera housing 11a, 11b receiving a camera in an inside volume for obtaining a predetermined area image; a fixing bracket 13 for securing the camera housing 11a, 11b in a rotatable way; and a coupling unit 15 connected to an inside part of the camera housing 11a, 11b and coupled to an electric device or a fixed object.

### BACKGROUND OF THE INVENTION

### 1. Field of the Invention

The present invention relates to a surveillance camera with a rotation coupling structure, in particular a surveillance camera to be coupled to a main device or an electric device such as a black box in a rotatable way for monitoring various areas.

### 2. Description of the Related Art

A black box for a vehicle may comprise an EDR (Event Data Recorder) to record an ECU (Electric Control Unit) data on detecting an impact at an air back sensor and a camera apparatus to record a road condition out of the vehicle and a vehicle condition with a camera. The black box with a camera to record a situation around the vehicle can record the outside situation of the vehicle on running, and can store a particular situation when an event occurs. The black box may have one channel structure monitoring a front area of the vehicle or two channel structure monitoring a front and a rear area of the vehicle. In relation to such black box, Korean patent publication number 10-2015-0065400 discloses a black box installed within a vehicle. and Korean patent registration number 10-1698822 discloses a black box to be used as a rear camera. Such known black box may store an image obtained with a camera installed in a predetermined direction, and therefore, the black box can obtain only a monitoring image related to a front or a rear predetermined area. However, depending on a use of the vehicle or a kind of the vehicle, it is necessary to obtain an inside image of the vehicle or to obtain a surveillance image related to a front or a rear blind area. In the case of a surveillance camera for such a purpose, it is advantage that the surveillance camera has a direction setting function and a structure detachable to the black box. However, the prior art discloses no surveillance camera to have such function.

The present invention has the following object for solving the prior art problems.

### PURPOSE OF THE INVENTION

An object of the present invention is to provide with a surveillance camera module detachable to a monitoring apparatus such as a black box and adjusting a monitoring area, wherein the surveillance camera module can be coupled to the black box in a rotatable way.

### SUMMARY OF THE INVENTION

In one embodiment of the present invention, a surveillance camera module with a rotation coupling structure comprises a camera housing receiving a camera in an inside volume for obtaining a predetermined area image; a fixing bracket for securing the camera housing in a rotatable way; and a coupling unit connected to an inside part of the camera housing and coupled to an electric device or a fixed object.

In other embodiment of the present invention, the camera module further comprises a rotation regulating unit coupled to the fixing bracket in a gear coupling structure for rotating the camera housing.

In another embodiment of the present invention, the camera module further comprises a magnet unit coupled to the fixing bracket.

In still another embodiment of the present invention, a black box apparatus comprises a monitoring image treating module for obtaining an image to at least one direction and treating the image; a camera module capable of obtaining an image to a predetermined area; and a coupling unit for coupling the camera module to the monitoring image treating module in a rotatable way, wherein the image obtained by the camera module is transmitted to the monitoring image treating module through the coupling unit. [9] The camera module with a rotation coupling structure of the present invention may be coupled to the black box installed detachably inside a vehicle, and be coupled to the black box in rotatable way to various directions. The camera module can obtain a surveillance image related to an inside of a vehicle and can monitor a blind area not to be covered by the black box. The camera module may be coupled detachably to various apparatuses capable of treating an image for obtaining a surveillance image to various areas.

### BRIEF DESCRIPTION OF THE DRAWINGS

FIG. 1 shows an embodiment of a surveillance camera with a rotation coupling structure according to the present invention.

FIG. 2 shows an embodiment of a rotation structure of the surveillance camera according to the present invention.

FIG. 3 shows an embodiment of an application form according to present invention.

FIG. 4 shows an embodiment of the surveillance camera coupled to a vehicle black box according to the present invention.

### DETAILED DESCRIPTION OF EXEMPLARY EMBODIMENTS

Exemplary embodiments of the present invention will be described herein below with reference to the accompanying drawings.

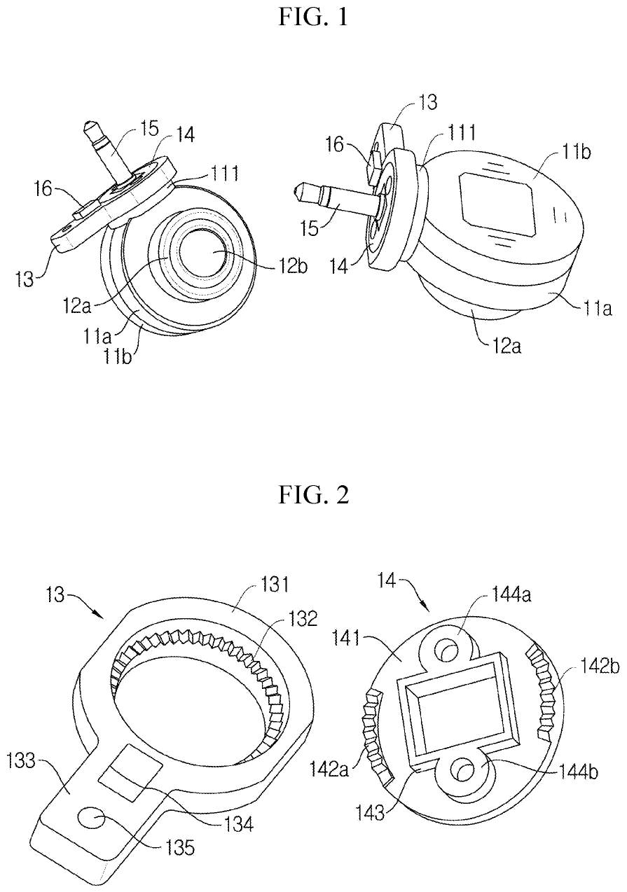

FIG. 1 shows an embodiment of a surveillance camera with a rotation coupling structure according to the present invention.

Referring to FIG. 1, a surveillance camera module with a rotation coupling structure comprises a camera housing 11a, 11b receiving a camera in an inside volume for obtaining a predetermined area image; a fixing bracket 13 for securing the camera housing 11a, 11b in a rotatable way; and a coupling unit 15 connected to an inside part of the camera housing 11a, 11b and coupled to an electric device or a fixed object.

The camera module may comprise a camera for obtaining a video image continuously, a treating processor for treating the video image obtained by the camera and a transmitting means for transmitting the image data treated by the treating process. The camera module may operate independently, or operate by a power supplied by some apparatus. For example, the surveillance camera module may be coupled to the black box installed at the vehicle, and transmit the video data to the black box. And also, the necessary power for operating the camera module may be supplied from the black box. The data transmission and the power supply may be performed in various way, not limited to. A detecting sensor and an electric board such as a printed circuit board may be installed within the camera housing 11a, 11b, and the camera housing 11a, 11b may have a cylindrical shape in general, not limited to. The camera housing 11a, 11b may comprise a base housing 11b for arranging the electric board or an operating element; and a cover housing 11a for covering the base housing 11b and for arranging a guiding unit 12a and an opening 12b. A lens for guiding an incident light for obtaining the video image or a sensor module for sensing a guided light may be arranged at the guiding unit 12a, and the light may enter the opening 12b. The light entering the opening 12b may be transmitted to an inner part of the camera housing 11a, 11b through the guiding unit 12a to be converted as an electric signal after being detected by the sensor module such as a CCD (Charge Coupled Device) or a CMOS (Complementary Metal Oxide Semiconductor). The converted electric signal may be treated by a processor mounted at the electric board to be converted into an image data, and then the image data may be stored at a memory, or may be delivered to the main device such as the black box for storing. Various parts or elements for treating a surveillance image may be arranged within the camera housing 11a, 11b, not limited to. A connecting portion 111 with a cylindrical shape may be formed at one portion of the camera housing 11a, 11b, and the fixing bracket 13 may be coupled to the connecting portion 111. The fixing bracket 13 may be a flat shape in general, and the fixing bracket 13 may comprise a coupling portion coupled to the connecting portion 111 and a fixing portion extending from the coupling portion in a protruding shape. The fixing bracket 13 may have a function to secure the camera housing 11a, 11b to the main device such as the black box and at the same time the camera housing 11a, 11b may be coupled in a rotatable way. In particular, one side of the fixing bracket 13 may be coupled to the connecting portion 111, and the other side of the fixing bracket 13 may be secured to the main device. For example, a magnet unit 16 may be installed at one side of the fixing bracket 13 for securing the fixing bracket 13 to the main device firmly. The rotation regulating unit 14 may be coupled to the fixing bracket 13 in a rotatable way, and the rotation regulating unit 14 may be coupled to the connecting portion 111. According to this structure, if the camera housing 11a, 11b is rotated, then the rotation regulating unit 14 may be rotated to the fixing bracket 13. And the camera housing 11a, 11b may be rotated in a state that the fixing bracket 13 is fixed, thereby the surveillance camera module may be arranged so that the guiding unit 12a faces a predetermined direction. The coupling unit 15 may extend outwardly in a state of being connected to the inner part of the camera housing 11a, 11b, and the coupling unit 15 may have, for example, a bolt or a nail shape. The coupling unit 15 may have a structure to be inserted into a coupling hole formed at the main device for fixing. The coupling unit 15 may have a function to couple the camera module to the main device and at the same time to connect the camera module to the main device electrically, and accordingly the coupling unit 15 may have a function of an electrical connector or a communication jack. Specifically, the power may be supplied from the main device such as the black box to the camera module through the coupling unit 15, and the image data generated at the camera module may be transmitted to the black box through the coupling unit 15. The power supply to the camera module or the data communication between the camera module and the main device may be performed in various ways, not limited to.

FIG. 2 shows an embodiment of a rotation structure of the surveillance camera according to the present invention.

Referring to FIG. 2, the fixing bracket 13 may comprise a bracket body 131 in a ring shape and with some thickness and a fixing tab 133 having a rectangular plate shape and extending outwardly from one part of the bracket body 131. An engaging gear block 132 with a circular tooth structure may be formed along an inner circumferential surface of the bracket body 131, and the magnet fixing groove 134 may be formed at the fixing tab 133. And also, a coupling hole 135 may be formed at the fixing tab 133, and the fixing bracket 13 may be secured to the main device by a coupling means such as a fixing pin to be coupled to the coupling hole 135. The rotation regulating unit 14 may be coupled to the bracket body 131, and the rotation regulating unit 14 may be a circular plate in general. The bracket body 131 may have a ring shape with both sides open, the camera housing 11a, 11b may be coupled to one open side of the bracket body 131, and the rotation regulating unit 14 may be coupled to the other open side of the bracket body 131. The rotation regulating unit 14 may comprise a coupling body 141 having a circular plate shape as a whole; an engagement regulating blocks 142a, 142b formed along the circumferential direction at positions of the coupling body 141 facing each other; and a coupling wall 143 formed at a centering portion of the coupling body 141. The engagement regulating block 142a, 142b may be made as a toothed structure rotating in a state of engaging with the engaging gear block 132, and for example, the engagement regulating blocks 142a, 142b may be formed in a length corresponding to a circumferential angle of 5 to 45 degrees, but the engaging regulating blocks 142a, 142b may have various lengths, not limited to. The coupling wall 143 may be the connecting portion formed at the camera housing 11a, 11b. The coupling wall 143 may have a rectangular border structure, and a pair of fixing holes 144a, 144b may be formed at an outer portion of the facing walls of the coupling wall 143. The rotation regulating unit 14 may be coupled the camera housing by fixing pins coupled to the fixing holes 144a, 144b. The rotation regulating unit 14 may be secured to the camera housing firmly and the rotation regulating unit 14 may be coupled to the fixing bracket 13 in a rotatable way by the engagement regulating blocks 142a, 142b. As a result, the camera housing 11a, 11b may be coupled to the fixing bracket 13 in a rotatable way. The rotation regulating unit 14 may be coupled to the fixing bracket 13 in various ways, not limited to.

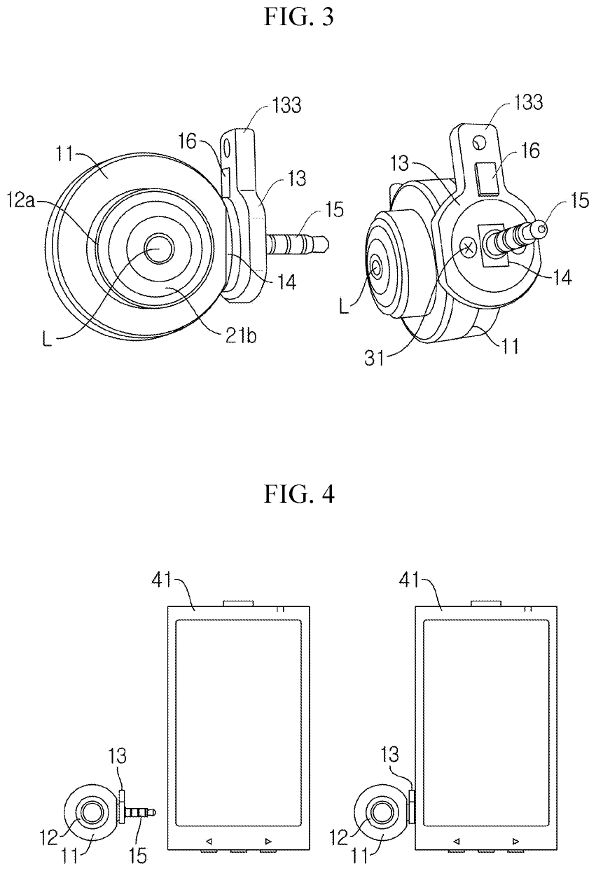

FIG. 3 shows an embodiment of an application form according to present invention.

Referring to FIG. 3, the camera housing 11 may have a cylindrical shape, the guiding unit 12a with a cylindrical shape and the opening 12b may be formed at one side of the camera housing 11, and the lens L may be arranged at the center of the opening 12b for entering an image light. Various sensor module and some electrical elements for detecting an incident image light and converting the incident image into an image data may be installed within the camera housing 11. The coupling unit 14 may have a function of a connecting jack for a power supply and a data communication, and the coupling unit 15 may be inserted into a hole port with a hole shape and formed at the main device such as the black box for fixing the camera module and connecting the camera module to the main device electrically. To this end, a supply terminal and a communicating terminal may be formed at the coupling unit 15. The rotation regulating unit 14 may be coupled to the fixing bracket 13 in a rotatable way and at the same time the rotation regulating unit 14 may be secured to the camera housing 11 by a coupling pin 31. The fixing bracket 13 may be stably fixed at the main device such as the black box by the magnet unit 15 arranged at the fixing tab 133. In this way, the camera module may be operated in a state of being coupled to the main device such as the black box.

FIG. 4 shows an embodiment of the surveillance camera coupled to a vehicle black box according to the present invention.

Referring to FIG. 4, the black box apparatus may comprise a monitoring image treating module 41 for obtaining an image to at least one direction and treating the image; a camera module capable of obtaining an image to a predetermined area; and a coupling unit 15 for coupling the camera module to the monitoring image treating module 41 in a rotatable way, wherein the image obtained by the camera module is transmitted to the monitoring image treating module through the coupling unit 15. The main device may be the monitoring image treating module 41 such as the black box, and the monitoring image treating module 41 may have a function to process the data from the camera installed at a front and rear part of the vehicle. The hole port where the coupling unit 15 may be coupled may be formed at one circumferential side of the monitoring image treating module 41, and the fixing bracket 13 may be fixed at one circumferential side of the monitoring image treating module 41. If the camera module is coupled to the monitoring image treating module 41, then the camera housing 11 may rotate in various directions, and the image light of the predetermined area may be transmitted through the guiding module 12 to be treated by a processor installed within the camera housing 11. The treated image data may be transmitted to the monitoring image treating module 41 through the coupling unit 15 for storing or displaying. The monitoring image treating module 41 may process the video image obtained from the camera installed at the front or rear portion of the vehicle, and at the same time the monitoring image treating module 41 may process the video image obtained from the surveillance camera module. An image related to a driver behavior before or after an accident occurs in a course of running the vehicle may be obtained by the camera module. Specifically, a foot position or an action of the driver may be detected by the camera module when a sudden acceleration happens. And also, various accidental circumstances happening within the vehicle may be detected by the camera. Furthermore, an image of an area that can't be detected by the black box may be obtained by the camera module. The camera module may be coupled or decoupled to the black box, if necessary, and thereby the convenience may be improved.

The present invention may enhance the function of the black box and various kinds of incidents or scenes of an incident can be recorded.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A surveillance camera module with a rotation coupling structure, comprising:
a camera housing receiving a camera in an inside volume for obtaining a predetermined area image;
a fixing bracket for securing the camera housing in a rotatable way; and
a coupling unit connected to an inside part of the camera housing and coupled to an electric device or a fixed object.

2. The camera module according to claim 1, wherein the camera module further comprises a rotation regulating unit coupled to the fixing bracket in a gear coupling structure for rotating the camera housing.

3. The camera module according to claim 1, wherein the camera module further comprises a magnet unit coupled to the fixing bracket.

4. A black box apparatus, comprising:
a monitoring image treating module for obtaining an image to at least one direction and treating the image;
a camera module capable of obtaining an image to a predetermined area; and
a coupling unit for coupling the camera module to the monitoring image treating module in a rotatable way,
wherein the image obtained by the camera module is transmitted to the monitoring image treating module through the coupling unit.
